(19) United States
(12) Patent Application Publication
(10) Pub. No.: US 2009/0207720 A1
(43) Pub. Date: Aug. 20, 2009

(54) VIBRATION-ISOLATING FIXING DEVICE

(75) Inventor: Wui-Lun LIN, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/101,009

(22) Filed: Apr. 10, 2008

(30) Foreign Application Priority Data
Feb. 20, 2008 (TW) 097105866

(51) Int. Cl. G11B 23/02

(52) U.S. Cl. 369/263.1

(57) ABSTRACT

A vibration-isolating fixing device is disposed in a chassis of an electronic device, for accommodating at least one storage device. The fixing device includes a frame to accommodating the storage device and a plurality of vibration-isolation elements. Each vibration-isolation element has a main body and a damper. Each assembly pillar is protruded from one side of the main body and is inserted into an assembly hole on a bottom plate of the frame, such that the vibration-isolation element is fixed on a bottom surface of the frame. The damper is sleeved on the other side of the main body opposite to the assembly pillar, and contacts with the chassis, so as to absorb vibration energy borne by the frame from three-dimensional directions.

### CROSS-REFERENCE TO RELATED APPLICATIONS

This non-provisional application claims priority under 35 U.S.C. § 119(a) on Patent Application No(s). 097105866 filed in Taiwan, R.O.C. on Feb. 20, 2008, the entire contents of which are hereby incorporated by reference.

### BACKGROUND OF THE INVENTION

1. Field of the Invention

The present invention relates to a fixing structure of a storage device, and more particularly to a vibration-isolating fixing device.

2. Related Art

Generally, at least one non-volatile storage device is configured in a computer, for example, hard disk and optical disk drive, so as to store an operating system that executes functions of the computer and reading and writing a large number of data. Therefore, a fixing device is generally designed within a chassis of the computer, so as to fix the storage device in the chassis.

Taking the hard disk for an example, in a conventional hard disk fixing manner, generally, the hard disk is directly locked to a hard disk frame within the chassis through using a plurality of screws. Alternatively, a sheet metal punching process is first performed on two opposite side plates of the hard disk frame, so as to bend the side plates to form a positioning supporting device and a fixing base having folded edges. The hard disk is supported by the positioning supporting device, and a snapping part is respectively installed on one side surface of the hard disk, for mutually snapping with the fixing base, thereby supporting and fixing the hard disk in the hard disk frame.

In order to have certain structural strength, the hard disk frame for fixing the hard disk is mostly fabricated by rigid materials and directly fixed in the chassis. The conventional storage device, such as hard disk or optical disk drive, is fixed in the hard disk frame by directly contacting with the hard disk frame, and as a result, the vibration generated when a heat sink fan in the computer device operates is directly delivered to the hard disk frame. What's worse, the microseism energy is generated when the storage device operates. Both the vibration energy and the microseism energy extremely easily result in a mutual resonance effect with the hard disk frame. Furthermore, under the synergistic effect of the resonance frequency in the inner space of the computer, the generated resonance noises are rather serious, and the storage device is easily damaged because of the resonance of the frame, thereby reducing the service life of the storage device.

In order to solve the problem of causing vibration to the conventional hard disk frame, a plurality of vibration-isolation pads is additionally mounted on the bottom plate where the hard disk frame contacts with the chassis. The conventional vibration-isolation pads is made by a plastic material, and the two opposite contacting surfaces for each vibration-isolation pad are designed into planar configurations, such that the vibration-isolation pad is attached to the hard disk frame and the chassis with the maximum contacting area.

However, as the conventional vibration-isolation pad is a flat plate structure, it is restricted to merely absorbing the vibration energy transferred to the frame from two-dimensional directions. If excessive large vibration energy is transferred to the frame, the vibration absorption efficiency provided by the vibration-isolation pads is not sufficient for dealing with the excessive large vibration energy, such that the storage device installed in the frame may be easily affected by the vibration energy and thus being damaged.

### SUMMARY OF THE INVENTION

In view of the above problem, the present invention provides a vibration-isolating fixing device, so as to solve the problems that the conventional hard disk fixing device does not have desirable buffering function, and the vibration absorption efficiency of the conventional vibration-isolation pad is still not sufficient for dealing with the excessive large vibration energy, and as a result, the storage device is easily damaged by the external vibration.

The vibration-isolating fixing device of the present invention is disposed in the chassis of the electronic device, for accommodating at least one storage device. The fixing device includes a frame and a plurality of vibration-isolation elements. The frame includes an accommodation space for the storage device to be installed therein, and a plurality of assembly holes is opened on a bottom plate of the frame facing the chassis. Each vibration-isolation element has a main body and a damper. Each assembly pillar is protruded from one side of the main body and is inserted into the assembly hole, such that the vibration-isolation element is fixed on the bottom plate of the frame. The damper is sleeved on the other side of the main body opposite to the assembly pillar, and contacts with the chassis, so as to absorb vibration energy of the frame from three-dimensional directions.

In the vibration-isolating fixing device of the present invention, a plurality of vibration-isolation elements formed by the main body and the damper is installed on the bottom plate of the frame, and the frame contacts with the chassis through the damper sleeved on the main body, so that a vibration absorption function is provided to absorb the vibration energy borne by the frame from three-dimensional directions, and thus protecting the storage device from being affected by the vibration energy.

### BRIEF DESCRIPTION OF THE DRAWINGS

The present invention will become more fully understood from the detailed description given herein below for illustration only, which thus is not limitative of the present invention, and wherein:

FIG. 1 is an exploded view of the present invention;

FIG. 2 is a perspective view of the present invention; and

FIG. 3 is a cross-sectional view of the present invention.

### DETAILED DESCRIPTION OF THE INVENTION

The vibration-isolating fixing device of the present invention is used to accommodating one or more storage devices which likes a non-volatile storage device fixed within the chassis of the computer, such as a hard disk drive, a soft disk drive, an optical disk drive, a disk recorder, but not limit to the above-mentioned computer devices. In the following detailed description of the present invention, the hard disk drive is taken as the most preferred embodiment of the present invention. However, the accompanying drawings are only intended to make reference and demonstration, but not to limit the scope of the present invention.

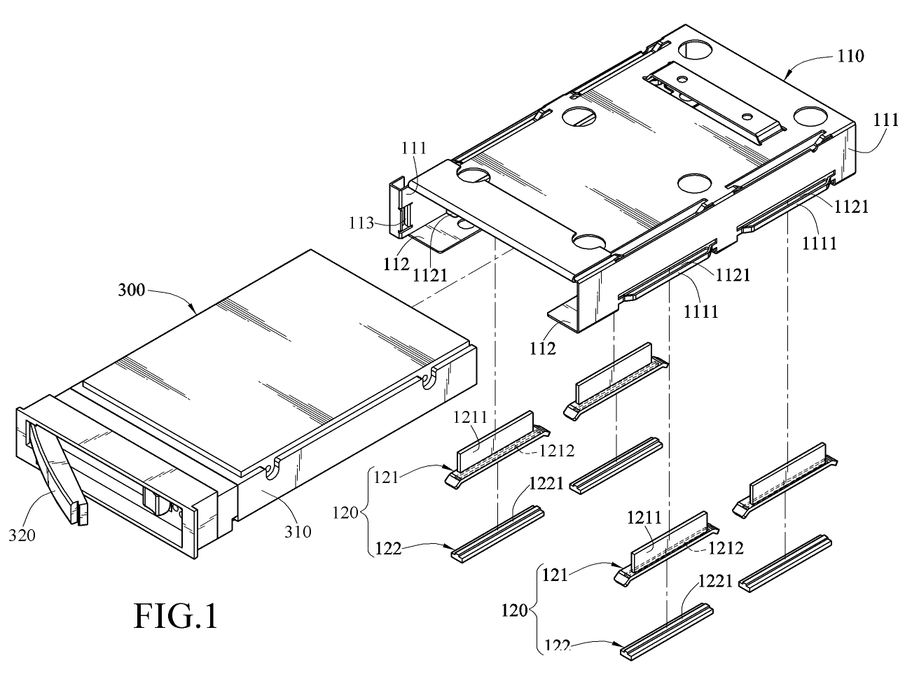

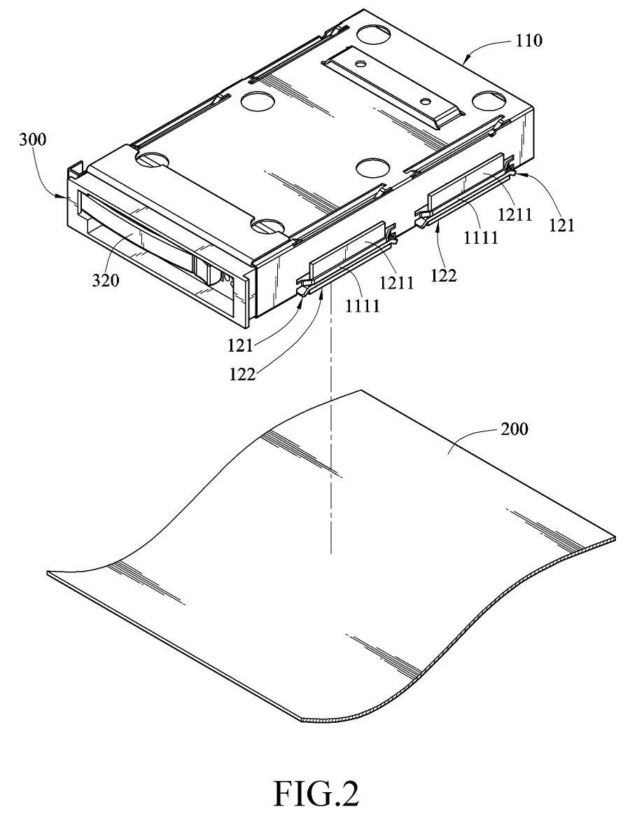

FIG. 1 to FIG. 3 are schematic views of a vibration-isolating fixing device according to the present invention. The fixing device of the present invention is installed in a chassis 200 of an electronic device (not shown), for accommodating one or more storage devices 300. The electronic device of the present invention such as a desktop computer, a notebook computer, a server, and other electronic device installed with at least one storage device, but not limit to the above-mentioned computer devices.

The fixing device includes a frame 110 and a plurality of vibration-isolation elements 120. The frame 110 has two opposite side plates 111 and a bottom plate 112 abutting to the side plates 111. An accommodation space with a width equivalent to that of the storage device 300 is formed between the two side plates 111, so as to accommodate the storage device 300 between the two side plates 111. The bottom plate 112 faces to the chassis 200 and a plurality of assembly holes 1121 is opened on the bottom plate 112. The assembly holes 1121 are formed by directly performing a punching process on predetermined positions of the bottom plate 112, such that the punched portions of the bottom plate 112 become elongated slot holes. Then, it punches outwards at the positions of the two side plates 111 close to the assembly holes 1121, so that a plurality of stop portions 111 is protruded from the side plates 111.

The storage device 300 is pushed into the frame 110 through slide rails 310 installed on the two sides thereof, and then, by means of buckling a fixing unit 320 pivoted to one end of the storage device 300 into a positioning hole 113 at an edge of the side plate 111, thereby fixing the storage device 300 in the frame 110 without being loosened.

Each vibration-isolation element 120 has a main body 121 and a damper 122. Each main body 121 has an assembly pillar 1211 matching with the shape of the assembly hole 1121 protruded from one side thereof, and has a combining slot 1212 protruded from the other side. The damper 122 is made of a rubber material, so as to effectively absorb the vibration energy. A combining block 1221 matching with the shape of the combining slot 1212 is protruded on one side of the damper 122. The damper 122 is embedded on the bottom side of the main body 121 through engaging the combining block 1221 with the combining slot 1212. Each assembly pillar 1211 of the main body 121 is respectively inserted in the assembly hole 1121, one side of the main body 121 opposite to the frame 110 is attached to the bottom plate 112 of the frame 110, and each assembly pillar 1211 is retained in the assembly hole 1121 through the stop portion 1111, such that the vibration-isolation element 120 is fixed on the bottom plate 112, and the damper 122 is slightly protruded from the bottom part of the frame 110. An appropriate number of vibration-isolation elements 120 in the present invention may be correspondingly disposed depending upon the practical size of the frame 110, so as to ensure the stability when installing the frame 110 in the chassis 200. However, the number of the vibration-isolation elements 120 is not limited to this embodiment.

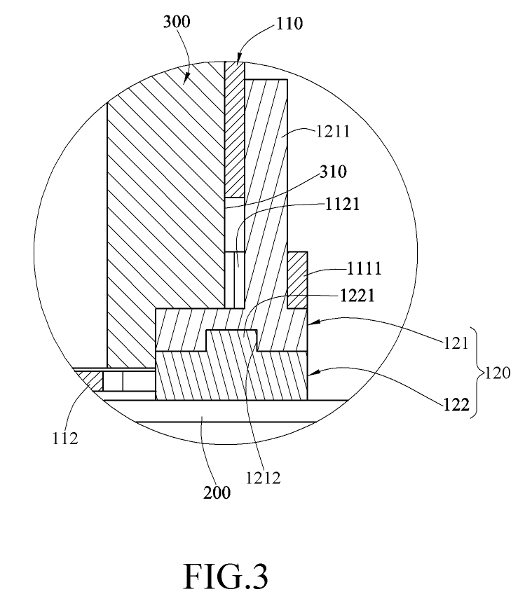

Please refer to FIG. 1 and FIG. 3, when the frame 110 is installed in the chassis 200, the damper 122 of the vibration-isolation elements 120 contacts with the chassis 200, so as to prevent the frame 110 from directly contacting with the chassis 200. The damper 122 absorbs the vibration energy transferred from the chassis 200 to the frame 110, or absorbs the vibration energy generated by the storage device 300 during operation, so as to protect the storage device 300 from being damaged due to being influenced by the vibration energy. Also, in the present invention, since the damper 122 made of the rubber material has compressible deformation characteristics, the combining block 1221 protruded from one side of the damper 122 can achieve a vibration absorption efficiency for absorbing the vibration energy transferred to the frame 110 from the three-dimensional directions, so as to effectively neutralize a part of the vibration energy transferred to the frame 110 from each direction.

Furthermore, the fixing devices of the present invention can be stacked with each other, so as to install a plurality of storage devices 300 in the electronic device. Under such circumstance, the bottom side of the fixing device 100 contacts with the top surface of another fixing device 100 or the chassis 200 of the electronic device through the vibration-isolation elements 120, so as to absorb the vibration energy.

In the vibration-isolating fixing device of the present invention, a plurality of vibration-isolation elements formed by the main body and the damper is installed on the bottom plate of the frame, and the damper contacts with the chassis through engaging the combining block with the combining slot of the main body, such that the damper can absorb the vibration energy borne by the frame from three-dimensional directions, so as to protect the storage device from being damaged due to being influenced by the vibration energy.

What is claimed is:

1. A vibration-isolating fixing device, disposed in a chassis of an electronic device, for accommodating at least one storage device, comprising:
a frame, having an accommodation space, for the storage device to be installed therein, wherein a plurality of assembly holes is opened on a bottom plate of the frame facing the chassis; and
a plurality of vibration-isolation elements, wherein each vibration-isolation element comprises:
a main body, having an assembly pillar on one side, wherein the assembly pillar is inserted in the assembly hole, so as to fix the vibration-isolation element on the frame; and
a damper, sleeved on the other side of the main body opposite to the assembly pillar and contacting with the chassis, for absorbing vibration energy borne by the frame from three-dimensional directions.

2. The vibration-isolating fixing device as claimed in claim 1, wherein the frame further has two opposite side plates, and each side plate has at least one stop portion adjacent to the assembly hole.

3. The vibration-isolating fixing device as claimed in claim 1, wherein the main body has a combining slot, the damper has a combining block, and the combining block is engaged in the combining slot, so as to fix the main body with the damper.

4. The vibration-isolating fixing device as claimed in claim 1, wherein the damper is made of a rubber material.
